(19) United States
(12) Patent Application Publication
(10) Pub. No.: US 2021/0116011 A1
(43) Pub. Date: Apr. 22, 2021

(54) SPROCKET WITH VIBRATION ABSORPTION PROPERTIES

(71) Applicant: BorgWarner Inc., Auburn Hills, MI (US)

(72) Inventor: Matthew W. Crump, Cortland, NY (US)

(21) Appl. No.: 17/133,730

(22) Filed: Dec. 24, 2020

Related U.S. Application Data
(62) Division of application No. 16/022,814, filed on Jun. 29, 2018.

(51) Int. Cl. F16H 55/14; F16H 7/06; F16H 55/30

(52) U.S. Cl. CPC F16H 55/14; F16H 2055/306; F16H 55/30; F16H 7/06

(57) ABSTRACT

Provided is a sprocket having a body formed by a powder metallurgy process with a predetermined density and vibration energy absorbing properties, and teeth with a greater density than the density of the body, and a method of making the same. The sprocket minimizes mechanical vibration during a chain-to-sprocket tooth contact. The teeth of the sprocket have a higher density than the body of the sprocket.

### TECHNICAL FIELD OF THE INVENTION

The present inventive concept relates to a sprocket used with timing chain systems and a method of making the same. More particularly, the present inventive concept pertains to a sprocket including a body having vibration energy absorbing properties, and including teeth with a higher density than the body and with wear resistant properties. More particularly, the present inventive concept pertains to a sprocket including wear resistant properties, a body having vibration energy absorbing properties, and teeth with a higher density than the body.

### BACKGROUND OF THE INVENTION

Sprockets are used to a large extent in a variety of applications including, but not limited to, automotive timing chain systems. These sprockets can be subjected to high levels of vibration and wear during operation and over time. As a result of such vibrations these sprockets can cause poor performance to the systems used therein during operation or damage to the sprocket and/or other components of the system used therein during operation. Moreover, the sprockets may have a short performance life due materials in which they are formed, resulting in damage to or a short life of the other components in the system in which they are used.

Therefore the is a need for a sprocket that can absorb high levels of vibration energy during operation and can resist wearing to increase their life for long periods of time.

### SUMMARY OF THE INVENTION

The present inventive concept provides a sprocket usable with timing chain systems that absorb vibration energy during operation, and a method of making the same.

The foregoing and other features and utilities of the present inventive concept can be achieved by providing a method of forming a sprocket, including: compressing metal powder into a predetermined density solid to form a circular body; and impregnating a vibration energy absorption material into pores of the circular body.

According to an example embodiment, the circular body is formed with teeth surrounding the outer circumference thereof during the compressing step.

According to still another example embodiment, the method can further include applying a pressure along the teeth to increase the density of the teeth prior to impregnating the circular body.

According to still another embodiment of the present inventive concept, the density of the teeth can be increased by a process of rolling the teeth along at least one die.

According to still another example embodiment, the vibration energy absorption material can be an oil or a resin.

According to still another example embodiment, the impregnating process can be performed by applying a vacuum to a vat including the vibration energy absorption material until air within the pores is replaced with the vibration energy absorption material.

According to yet another example embodiment, the method can further include forming a ring of metal teeth having a density higher than the density of the circular body; and fixing an inner surface of the ring of metal teeth to an outer circumference of the circular body.

According to yet another embodiment of the present inventive concept, the ring of metal teeth and the circular body are fixed together by a splining process.

According to yet another example embodiment, the ring of metal teeth and the circular body are fixed together by press-fitting process.

According to yet another example embodiment, the ring of metal teeth is formed of steel.

The foregoing and other features and utilities of the present inventive concept can also be achieved by providing a vibration energy absorption sprocket, including: a circular metal body having a first density including a vibration energy absorbing material impregnated into pores therein; and teeth surrounding an outer circumference of the circular metal body and having a second density greater than the density of the circular metal body.

According to an example embodiment, the sprocket is formed of steel.

According to another example embodiment, the density of the metal body is approximately 6.6 grams/cm³.

According to another example embodiment, the density of the teeth is approximately 7.0 grams/cm³.

According to still another example embodiment, the vibration energy absorbing material is an oil or a resin.

According to still another example embodiment, the body and the teeth are formed together and the density of the teeth is increased by a rolling process.

According to yet another example embodiment, the body and the teeth are formed as separate parts and splined together.

According to yet another example embodiment, the body and the teeth are formed as separate parts and press-fit together.

According to yet another example embodiment, the body and the teeth are formed together and the density of the teeth is increased by a rolling process.

The foregoing and other features and utilities of the present inventive concept can also be achieved by providing a vibration energy absorption sprocket, including: a circular metal body having a first density and including vibration energy absorbing properties therein; and a ring of metal teeth surrounding an outer circumference of the circular metal body and having a second density greater than the first density of the circular metal body.

According to an example embodiment, the vibration energy absorbing properties are impregnated into the circular metal body.

According to another example embodiment, the ring of metal teeth is fixed to the circular metal body.

Additional features and utilities of the present general inventive concept will be set forth in part in the detailed description, which follows, and in part, will be obvious from the description, or may be learned by practice of the overall present inventive concept.

### BRIEF DESCRIPTION OF THE DRAWINGS

FIG. 1A illustrates a vibration energy absorbing sprocket according to an example embodiment of the present inventive concept.

FIG. 1B illustrates a cross-sectional view of the sprocket of FIG. 1A along a line A-A.

FIG. 2 illustrates a vibration energy absorbing sprocket, according to another example embodiment of the present inventive concept.

FIG. 3 illustrates a vibration energy absorbing sprocket, according to still another example embodiment of the present inventive concept.

### DETAILED DESCRIPTION OF THE INVENTION

As described above, the present inventive concept relates to a sprocket used with timing systems, and more particularly, to incorporating materials into a sprocket body and performing a densification of teeth of a sprocket to effectively absorb vibration energy of the sprocket and overall timing systems.

Reference will now be made in detail to the embodiments of the present general inventive concept, examples of which are illustrated in the accompanying drawings, wherein like reference numerals refer to the like elements throughout. The embodiments described below are intended to explain the present general inventive concept while referring to the figures. Also, while describing the present general inventive concept, detailed descriptions about related well-known functions or configurations that may diminish the clarity of the points of the present general inventive concept are omitted.

It should be understood that although the terms “first” and “second” are used herein to describe various elements, these elements should not be limited by these terms. These terms are used only to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description provided below. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the block may be embodied as hardware or software or embodied by combining hardware and software.

Hereinafter, one or more exemplary embodiments of the present general inventive concept will be described in detail with reference to accompanying drawings.

Porous metal components have been known to absorb high frequency noise and vibrations to a greater degree than higher density metal components. As the porosity of metal components increases, it has been found that high frequency noise and vibrations can be absorbed better.

Forming a metal sprocket by a powder metallurgy technique can include manufacturing of metal powder particles, mixing or blending the metal powder particles, compacting the mixed or blended particles, and then sintering the compacted particles. “Secondary operations” can also be used to finish the sintered product. Powder metallurgy provides the ability to achieve close control over the porosity of the metal product. Preferably low density metal powder is used.

The production of metal powder can be performed according to several different processes, such as, for example crushing the metal, grinding the metal, performing chemical reactions on the metal, electrolytic deposition of the metal, centrifugal disintegration, application of a high-speed stream of atomized water, etc.

Compacting the metal powder can also be performed according to several different processes. For example, the powder can be compacted in a die through the application of high pressures or by isostatic powder compacting. Isostatic powder compacting is performed by placing fine metal particles/powder into a flexible mould and then applying a high gas or fluid pressure to the mould. Compacting pressures can range from approximately 15,000 psi to 40,000 psi for most metals.

Sintering can also be performed by several different processes, including solid state sintering, which places the metal powder into a mold or die, and then applies a high heat for a long period of time. Due to this high heat bonding of the particles takes place between the porous particles. Once cooled the powder has bonded to form a solid sprocket. Other forms of sintering include passing high electric current through the metal powder to heat the rough edges of the metal powder particles under compacted pressure to create a plastic deformation. Another example of sintering can be performed by laser sintering.

The manufacturing of a sprocket by a powder metallurgy process can be controlled to create a much lower density sprocket, thus resulting in a lighter weight product as compared to a solid metal sprocket. The density of the formed sprocket by the powder metallurgy process can be approximately 6.6 g/cm³ (grams/cubic centimeter). However, a balance between a density high enough to provide sufficient structural integrity and also a sufficient percentage of absorption material when impregnating the vibration energy absorption material therein (described in more detail below) is taken into consideration when performing a powder metallurgy process. Metals that can be used in a powder metallurgy process to form a sprocket can include, but are not limited to, stainless steel, brass, copper, iron and bronze.

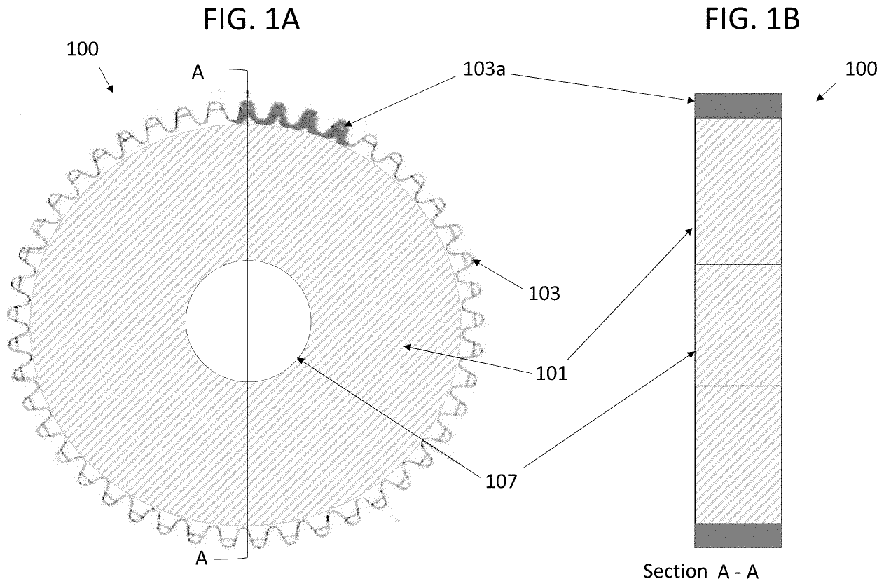

FIG. 1A illustrates an example embodiment of a sprocket 100 usable with timing chain systems. This sprocket 100 can be manufactured by a powder metallurgy process to form a highly porous, low density sprocket 100 including a body 101 and outer teeth 103. Also included is a camshaft or other shaft receiving hole 107.

In accordance with an example test conducted in a metallurgy laboratory, the sprocket 100 was formed to have a density of approximately 6.6 grams/cm³, which was found to be successful in maintaining the structural integrity of the body 101 while also being able to absorb the vibration energy absorbing material impregnated therein. The vibration energy absorbing materials tested include oils and resins, which were impregnated into the body 101 of the sprocket 100 so that the sprocket 100 would absorb a significant amount of vibration energy during operation within a timing chain system.

After the sprocket 100 is formed by the powder metallurgy process, and prior to impregnation of the body 101, the teeth 103 of the sprocket 100 can be subjected to a surface densification process to increase the tooth profile density to a level that approaches that of steel while maintaining the body 101 of the sprocket 100 at the desired lower density predetermined during the manufacturing process. Reference 103a illustrates the increased density of the teeth 103.

Rolling densification is one technique that can be implemented to increase the density of the teeth 103 of the sprocket 100 manufactured via a powder metallurgy process. By adding stress to the sprocket 100 using the rolling process, textures and structures in the surface layer of the teeth 103 can be changed via plastic deformation under room temperature, which can improve the physical and mechanical properties of the teeth 103. Therefore, the process of rolling densification is one technique used to achieve a high surface fineness and other desired properties of the teeth 103, such as a higher density and hardness. The density obtained during testing to achieve the desired hardness was approximately 7.0 g/cm³. However, the tooth densification process performed during testing have reached roughly 7.8 g/cm³, which is approximately the density of steel. After the rolling process, the resulting increased density teeth 103a have a greater wear resistance during operation.

Powder metallurgy manufactured components can be subjected to oils for two purposes. One purpose is to seal the component after manufacturing in order to reduce internal corrosion that can occur due to penetration of the pores via environmental elements. Another purpose, implemented with bearing, is where powder metallurgy manufactured bearings are made to self lubricate, wherein when a lubricating oil embedded within the pores is heated, the oil is released. Upon cooling of the bearings and oil, reabsorption of the oil into the bearing takes place due to capillary action.

In accordance with example embodiment, a sprocket 100 manufactured by a powder metallurgy technique, as described above, can be impregnated with an oil or resin, or other materials that can absorb vibration energy. Such a material must also have a viscosity such that it can be impregnated into the pores of the powder metallurgy manufactured sprocket 100. The process of impregnation of such vibration energy absorption materials into the sprocket body 101, such as an oil or a resin, can be performed by a process referred to as vacuum impregnation. In accordance with this process, the sprocket 100 manufactured by the powder metallurgy process can be placed in a vat of the vibration energy absorbing material having the impregnating capable viscosity. The vat can then be placed under a sufficient vacuum to decrease the pressure within the vat such that while air is being forced out of the pores, the material having the vibration energy absorbing qualities is forced into the pores. The vibration energy absorbing material remains in the pores due to the surface tension and friction of the sprocket body 101. Regarding the use of resins as vibration energy absorbing materials, their viscosities tend to change as they cool, thus making it more difficult for the resins to escape from the pores in which they were impregnated therein.

FIG. 1B illustrates a cross-sectional view along the line A-A of the sprocket 100 illustrated in FIG. 1A. As illustrated in FIG. 1B, the sprocket body 101 has a predetermined first density as a result of being manufactured by a powder metallurgy process. Low density powder particles are generally used to obtain a low density sprocket. After the rolling process conducted on the teeth 103, the resulting teeth have a predetermined second density (illustrated as 103a) higher than the first density of the body 101. The resulting sprocket 100 according to the example embodiment of FIG. 1A and FIG. 1B has a body 101 with vibration energy absorbing properties that result in smoother performance during operation within a timing chain system, and teeth 103a having wear resistant properties.

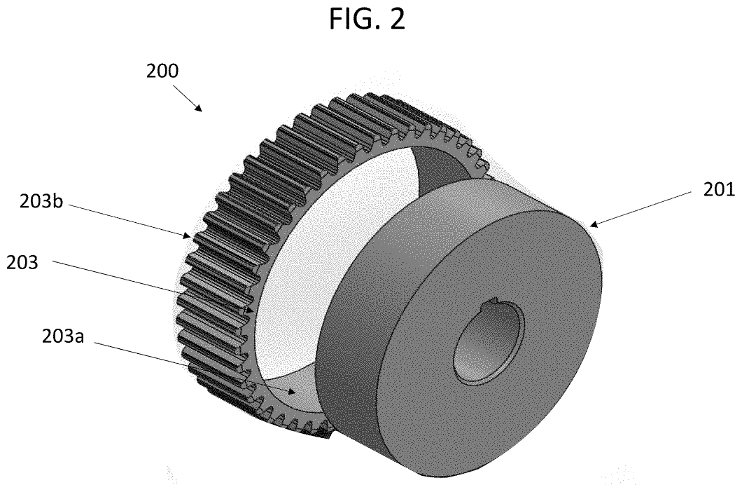

FIG. 2 illustrates another example embodiment of the present inventive concept. In accordance with this example embodiment, a sprocket 200 includes a body 201 that can be manufactured according to the same or similar types of powder metallurgy processes as described above, thus resulting in a similar low density sprocket 200 and body 201 as that described in the embodiment of FIGS. 1A and 1B. The sprocket body 201 will have a predetermined outer diameter. This outer diameter can be determined based on many factors, including, for example other corresponding sprockets within the chain driven system, the size of a chain being driven, the number of other devices being driven by the chain, etc. The sprocket body 201 can be impregnated with an oil or resin as described above with reference to FIGS. 1A and 1B, or with other materials having the proper viscosity and vibration energy absorbing qualities.

In this example embodiment the body 201 can be formed without teeth.

A separate process can be performed to mold a ring shaped metal body 203 having an inner surface 203a with a diameter approximately the same as, or slightly smaller than the outer diameter of the body 201. The metal can be steel or another type metal with similar properties as required to perform the intended purposes as described herein, such as a metal with a higher density than the body 201, and having wear resistance qualities. The metal body 203 can be formed to include teeth 203b surrounding an outer circumference thereof. The teeth 203b can be intermittent around the body 203 or the teeth 203b can surround the entire outer circumference of the metal body 203, depending on considerations such as, for example weight requirements.

The inner surface 203a of the ring shaped metal body 203 can be slid over the outer circumference of the sprocket body 201 after the sprocket body 201 is formed and impregnated with a vibration energy absorbing material. In this example embodiment the ring shaped metal body 203 can be permanently fixed over the outer circumference of the sprocket body 201 by a process referred to as press fit technology. This can achieved by interfacing the ring shaped metal body 203 with the outer circumference of the sprocket body 201 via a high force.

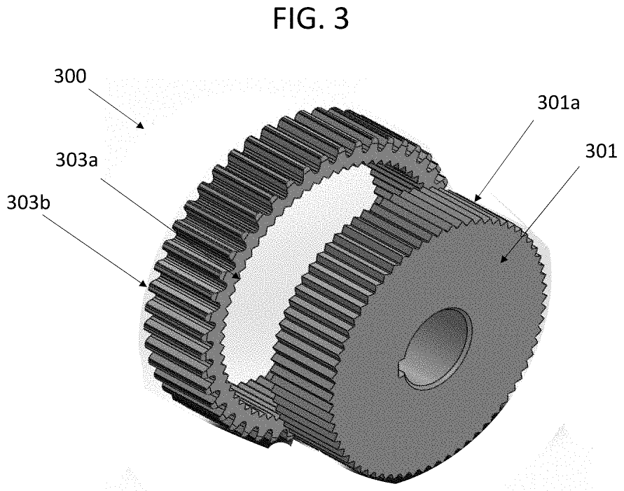

FIG. 3 illustrates another example embodiment of the present inventive concept. In accordance with this example embodiment, a sprocket 300 includes a body 301 that can be formed according to the same types of powder metallurgy processes as described above, without teeth, thus resulting in a similar low density sprocket as that of the embodiment of FIG. 2. However, the sprocket body 301 according to this example embodiment is formed with spline teeth 301a surrounding an outer circumference thereof. Additionally, as described above with reference to the example embodiment of FIG. 2, the sprocket body 301 can be impregnated with an oil or resin, or other materials that have vibration energy absorbing qualities and a viscosity capable of being impregnated into the pores of the powder metallurgy manufactured sprocket body 301.

Similar to the example embodiment of FIG. 2, a ring shaped metal body 303 can be formed separately of the powder metallurgy manufactured sprocket body 301. Additionally, in this example embodiment the ring shaped metal body 303 can include spline teeth 303a formed around an inner surface thereof which correspond with the spline teeth 301a of the sprocket body 301. The ring shaped metal body 303 can also include teeth 303b formed around an outer circumference thereof. The ring shaped metal body 303 can be formed of steel, or other similar high density wear resistant metals. Here the ring shaped metal body 303 can be fixed to the sprocket body 301 by a process a process referred to as splining, where the ridges of the teeth 301a of the body 301 mesh with the ridges of the teeth 303a of the ring shaped metal body 303. These teeth 301a and 303a mate such that an angular correspondence is maintained therebetween and a torque is transferred from the sprocket body 301 to the ring shaped metal body 303.

It is to be noted that other processes can be used to fix steel or other high density wear resistant metal teeth to an outer circumference of a powder metallurgy manufactured sprocket body, as disclosed herein, which provide the intended purposes as described herein.

Accordingly, it is to be understood that the embodiments as described herein are merely illustrative of the application of the principles of the overall inventive concept. Reference herein to details of the illustrated embodiments is not intended to limit the scope of the claims, which themselves recite those features regarded as essential to the invention.

1. A method of forming a sprocket, the method comprising the steps of:
compressing metal powder into a predetermined density solid to form a circular body; and
impregnating a vibration energy absorption material into pores of the circular body.

2. The method of claim 1, wherein the circular body is formed with teeth surrounding an outer circumference thereof during the compressing step.

3. The method of claim 2, further comprising:
applying a pressure along the teeth to increase the density of the teeth prior to impregnating the circular body.

4. The method of claim 3, wherein the density of the teeth is increased by a process of rolling the teeth along at least one die.

5. The method of claim 1, wherein the vibration energy absorption material is an oil or a resin.

6. The method of claim 5, wherein the impregnating process is performed by applying a vacuum to a vat including the vibration energy absorption material until air within the pores is replaced with the vibration energy absorption material.

7. The method of claim 1, further comprising:
forming a ring of metal teeth having a density higher than the density of the circular body; and
fixing an inner surface of the ring of metal teeth to an outer circumference of the circular body.

8. The method of claim 7, wherein the ring of metal teeth and the circular body are fixed together by a splining process.

9. The method of claim 7, wherein the ring of metal teeth and the circular body are fixed together by press-fitting process.

10. The method of claim 7, wherein the ring of metal teeth is formed of steel.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)
